(19) United States
(12) Patent Application Publication
(10) Pub. No.: US 2012/0222700 A1
(43) Pub. Date: Sep. 6, 2012

(54) TEMPLATE SUBSTRATE PROCESSING APPARATUS AND TEMPLATE SUBSTRATE PROCESSING METHOD

(76) Inventor: Takumi OTA, Yokohama-shi (JP)

(21) Appl. No.: 13/410,544

(22) Filed: Mar. 2, 2012

(30) Foreign Application Priority Data
Mar. 2, 2011 (JP) 2011-045423

(51) Int. Cl. B08B 7/00; B29C 59/02

(52) U.S. Cl. 134/1.1; 425/385

(57) ABSTRACT

According to one embodiment, a template substrate processing apparatus used in imprint lithography, includes a stage which has a convex portion that engages with a concave portion formed at an underside of the template substrate.

### CROSS-REFERENCE TO RELATED APPLICATIONS

This application is based upon and claims the benefit of priority from prior Japanese Patent Application No. 2011-045423, filed Mar. 2, 2011, the entire contents of which are incorporated herein by reference.

### FIELD

Embodiments described herein relate generally to a template substrate processing apparatus and a template substrate processing method.

### BACKGROUND

Imprint lithography (nanoimprint lithography) has been proposed as lithographic techniques for semiconductor devices.

A template which has a concave portion at its underside (or whose underside has been spot-faced) is sometimes used in imprint lithography. However, when a template with a concave portion at its underside is used, the following problems might occur.

A first problem occurs when a template is heated for processing. For example, when a template is cleaned, a stage on which a template is placed may be heated to increase a cleaning efficiency. However, since a concave portion is formed in the template, this makes heat conduction lower, causing the problem of being incapable of achieving a good heating efficiency.

A second problem occurs when a substrate on which a template pattern has not been formed yet (hereinafter, referred to as a pre-pattern-formation substrate) is placed on a stage and a high-frequency (RF) electric power is applied to the stage. For example, when a pre-pattern-formation substrate is subjected to reactive ion etching (RIE) to form a template pattern at the surface of the pre-pattern-formation substrate (an integrated-circuit-formation pattern formed at the surface of the template with trenches or the like), RF electric power is applied to the stage. However, since a concave portion is formed in the template, this causes the problem of being incapable of applying RF electric power to the pre-pattern-formation substrate efficiently. Thus, uniform processing may not be performed during patterning.

As described above, when a template substrate with a concave portion at its underside have been used, the problems of making heat conduction lower and of being incapable of applying RF electric power efficiently have been encountered.

### BRIEF DESCRIPTION OF THE DRAWINGS

FIG. 1 schematically shows the configuration of a processing apparatus according to a first embodiment;

FIG. 2 shows a state where a template is placed on a stage in the first embodiment;

FIG. 3 shows a state where the template is placed on the stage in the first embodiment;

FIG. 4 is a flowchart to explain an operation of the first embodiment;

FIG. 5 schematically shows the configuration of a processing apparatus according to a second embodiment;

FIG. 6 shows a state where a template is placed on a stage in the second embodiment;

FIG. 7 shows a state where the template is placed on the stage in the second embodiment;

FIG. 8 is a flowchart to explain an operation of the second embodiment; and

FIG. 9 is a flowchart to explain a semiconductor device manufacturing method.

### DETAILED DESCRIPTION

In general, according to one embodiment, a template substrate processing apparatus used in imprint lithography, includes a stage which has a convex portion that engages with a concave portion formed at an'underside of the template substrate.

Hereinafter, referring to the accompanying drawings, embodiments will be explained.

In the specification and claims described below, suppose a template substrate includes both a substrate on which a template pattern has already been formed and a substrate on which a template pattern has not been formed yet (a pre-pattern-formation substrate). A template substrate at the surface of which a template pattern has been formed is referred to as a template hereinafter.

### First Embodiment

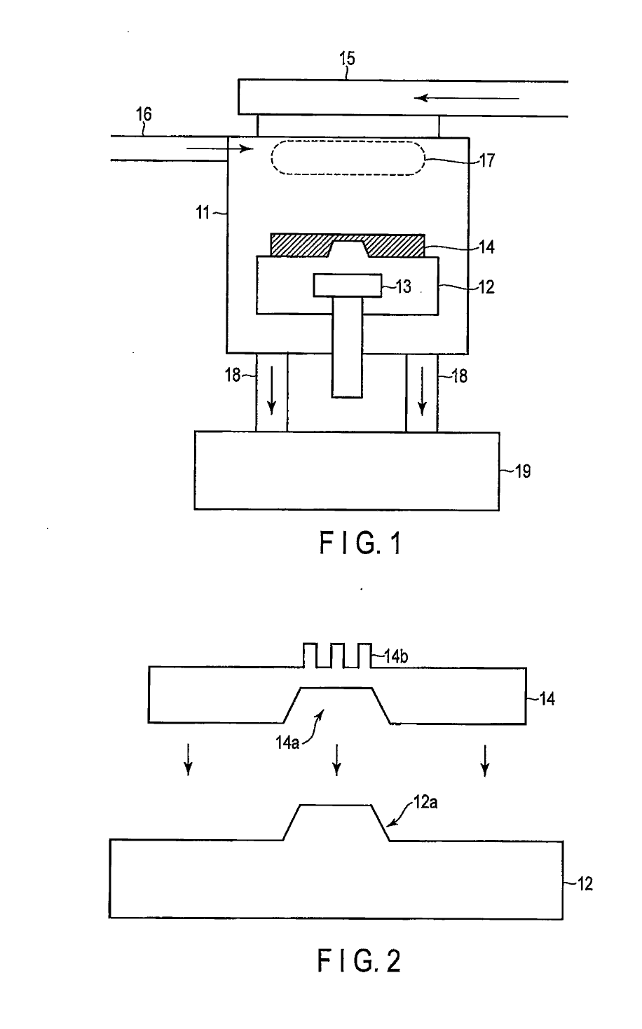

FIG. 1 schematically shows the configuration of a template (or a template substrate) processing apparatus used in imprint lithography.

The processing apparatus of FIG. 1 shows a plasma cleaning apparatus for cleaning a template. In imprint lithography, since an imprint agent, such as a light hardening resin, is brought into contact with a template pattern surface, a hardened imprint agent attached to the template pattern surface. To overcome this problem, the template needs cleaning.

In FIG. 1, a stage 12 is arranged in a processing container 11. A heater 13 is provided in the stage 12. The heater 13 is capable of heating a template 14 placed on the stage 12.

A microwave intake part 15 and a gas intake part 16 are provided outside the processing container 11. A specific cleaning gas (e.g., oxygen) is taken in from the gas intake part 16 and microwaves are taken in from the microwave intake part 15, with the result that plasma 17 is generated within the processing container 11. The plasma activates the cleaning gas, removing the imprint agent attached to the template 14.

The inside of the processing container 11 is configured to be evacuated by a pump 19 through an exhaust pipe 18.

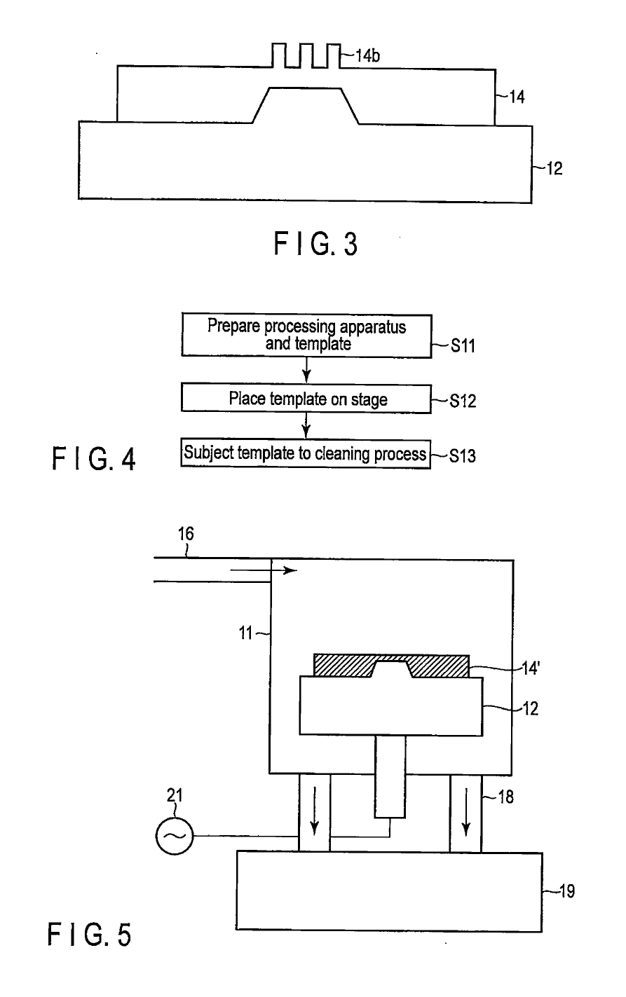

FIGS. 2 and 3 show a state where the template 14 is placed on the stage 12.

As shown in FIG. 2, a spot-faced concave portion 14a is formed at the underside of the template 14 (the face opposite to a pattern face on which a template pattern 14b has been formed). The stage 12 has a convex portion 12a that engages with the concave portion 14a of the template 14. The convex portion 12a has a cross-sectional area that decreases from bottom to top in a cross section parallel with the placing surface of the stage 12. Specifically, the convex portion 12a has a tapered shape.

As shown in FIG. 2, the template 14 is lowered from above the stage 12. Then, as shown in FIG. 3, the template 14 is placed on the stage 12 in such a manner that the concave portion 14a of the template 14 engages with the convex portion 12a of the stage 12.

FIG. 4 is a flowchart to explain an operation of the first embodiment.

First, a processing apparatus provided with the stage 12 having the convex portion 12a on it and the template 14 having the concave portion 14a in it are prepared and the template 14 is brought in the processing container 11 (S11).

Next, the template 14 is lowered from above the stage 12 with a transport mechanism (not shown) and is placed on the stage 12 in such a manner that the concave portion 14a of the template 14 engages with the convex portion 12a of the stage 12 (S12). At this time, since the convex portion 12a that engages with the concave portion 14a of the template 14 is provided on the stage 12, the area of contact between the stage 12 and template 14 can be increased. Therefore, when the template 14 is heated by the heater 13 provided in the stage 12, heat can be transferred from the stage 12 to the template 14 efficiently.

Since the convex portion 12a of the stage 12 and the concave portion 14a of the template 14 are tapered, even if the template 14 is a little out of alignment with the stage 12, the convex portion 12a of the stage 12 and the concave portion 14a of the template 14 can be caused to engage with each other automatically. Therefore, even if the template 14 is not aligned with the stage 14 accurately, the convex portion 12a of the stage 12 and the concave portion 14a of the template 14 can be caused to engage with each other reliably. Accordingly, a high-accuracy transport mechanism need not be provided, enabling the cost of the apparatus to be reduced.

Next, the template 14 placed on the stage 12 is subjected to a cleaning process as a specific process (S13). Specifically, cleaning gas is activated by plasma generated in the processing container 11. The imprint agent attached to the template 14 is removed by the activated cleaning gas. The cleaning process is performed with the stage 12 being heated by the heater 13. Since heat is transferred from the stage 12 to the template 14 efficiently, enabling the imprint agent attached to the template 14 to be removed reliably.

As described above, with the first embodiment, the convex portion 12a is provided at the top face of the stage 12 so as to engage with the concave portion 14a formed at the underside of the template 14. Therefore, heat can be transferred from the stage 12 to the template 14 efficiently, enabling the template to be cleaned reliably. In addition, since the convex portion 12a of the stage 12 and the concave portion 14a of the template 14 are tapered, the convex portion 12a and the concave portion 14a can be caused to engage with each other automatically. Therefore, a high-accuracy transport mechanism need not be provided, enabling the cost of the apparatus to be reduced.

After the plasma cleaning, a wet cleaning process may be performed. When heating is performed in the wet cleaning process, a convex portion as described above may be provided on the stage in the wet cleaning apparatus. In such a case, the same effect as described above can be obtained.

### Second Embodiment

Next, a second embodiment will be explained. Since the basic apparatus configuration and processing operations are the same as those of the first embodiment, what has been explained in the first embodiment will be omitted.

FIG. 5 schematically shows the configuration of a processing apparatus for a substrate on which a template pattern has not been formed yet (a pre-pattern-formation substrate). The apparatus of FIG. 5 is an etching apparatus (RIE apparatus) for forming integrated-circuit patterns (including trenches) at the surface of a pre-pattern-formation substrate. In FIG. 5, the structural elements corresponding to those of FIG. 1 in the first embodiment are indicated by the same reference numerals and a detailed explanation of them will be omitted.

The apparatus shown in FIG. 5 is provided with a high-frequency supplying module (RF power supply) 21 that supplies a high frequency (RF) to the stage 12. Plasma is generated by RF electric power, performing RIE, with the result that a desired template pattern is formed at the surface of a pre-pattern-formation substrate 14′.

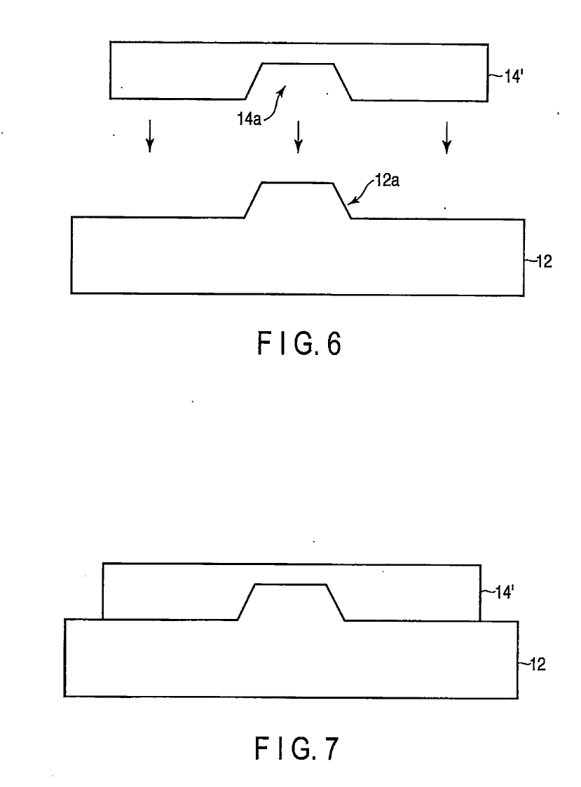

FIGS. 6 and 7 show a state where the pre-pattern-formation substrate 14′ is placed on the stage 12.

As shown in FIG. 6, a spot-faced concave portion 14a is formed at the underside of the pre-pattern-formation substrate 14′. As in the first embodiment, the stage 12 has a convex portion 12a that engages with the concave portion 14a of the pre-pattern-formation substrate 14′. The convex portion 12a has a cross-sectional area that decreases from bottom to top in a cross section parallel with the placing surface of the stage 12. Specifically, the convex portion 12a has a tapered shape.

As shown in FIG. 6, the pre-pattern-formation substrate 14′ is lowered from above the stage 12. Then, as shown in FIG. 7, the pre-pattern-formation substrate 14′ is placed on the stage 12 in such a manner that the concave portion 14a of the pre-pattern-formation substrate 14′ engages with the convex portion 12a of the stage 12.

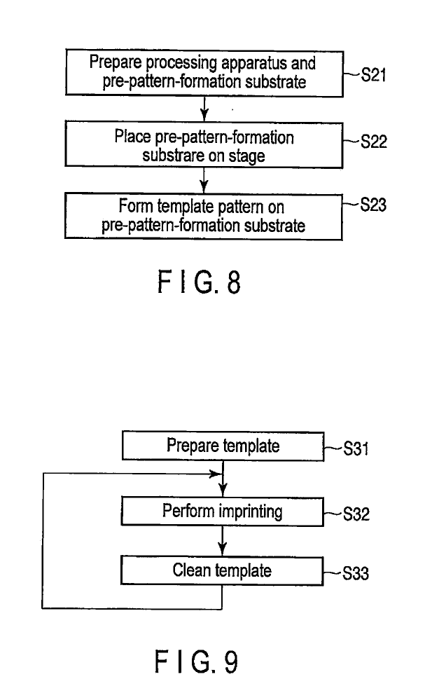

FIG. 8 is a flowchart to explain an operation of the second embodiment.

First, a processing apparatus provided with the stage 12 having the convex portion 12a on it and the pre-pattern-formation substrate 14′ having the concave portion in it are prepared and the pre-pattern-formation substrate 14′ is brought in the processing container 11 (S21).

Next, the pre-pattern-formation substrate 14′ is lowered from above the stage 12 with a transport mechanism (not shown) and is placed on the stage 12 in such a manner that the concave portion 14a of the pre-pattern-formation substrate 14′ engages with the convex portion 12a of the stage 12 (S22).

At this time, since the convex portion 12a that engages with the concave portion 14a of the pre-pattern-formation substrate 14′ is provided on the stage 12, the area of contact between the stage 12 and pre-pattern-formation substrate 14′ can be increased. Therefore, when the high-frequency supplying module 21 connected to the stage 12 supplies a high-frequency electric power to the pre-pattern-formation substrate 14′ to perform an RIE process, the pre-pattern-formation substrate 14′ can be subjected to the RIE process efficiently.

Since the convex portion 12a of the stage 12 and the concave portion 14a of the pre-pattern-formation substrate 14′ are tapered, even if the pre-pattern-formation substrate 14′ is a little out of alignment with the stage 12, the convex portion 12a of the stage 12 and the concave portion 14a of the pre-pattern-formation substrate 14′ can be caused to engage with each other automatically. Therefore, even if the pre-pattern-formation substrate 14′ is not aligned with the stage 14 accurately, the convex portion 12a of the stage 12 and the concave portion 14a of the pre-pattern-formation substrate 14′ can be caused to engage with each other reliably. Accordingly, a high-accuracy transport mechanism need not be provided, enabling the cost of the apparatus to be reduced.

Next, the pre-pattern-formation substrate 14′ placed on the stage 12 is subjected to an RIE process as a specific process to form a template pattern (S23). Specifically, to form an integrated-circuit pattern on the pre-pattern-formation substrate 14′ placed on the stage 12, the surface of the pre-pattern-formation substrate 14′ on which a desired resist pattern has been formed is subjected to an RIE process. The RIE process is performed in a state where a high frequency is being supplied to the stage 12. Since the surface of the pre-pattern-formation substrate 14′ is subjected to the RIE process efficiently, a semiconductor integrated-circuit template pattern can be formed accurately on the pre-pattern-formation substrate 14′.

As described above, with the second embodiment, the convex portion 12a is provided on the top face of the stage 12 so as to engage with the concave portion 14a formed at the underside of the pre-pattern-formation substrate 14′. Therefore, RIE electric power can be supplied to the pre-pattern-formation substrate 14′ placed on the stage 12 efficiently, enabling a template pattern to be formed on the pre-pattern-formation substrate 14′ accurately. In addition, since the convex portion 12a of the stage 12 and the concave portion 14a of the pre-pattern-formation substrate 14′ are tapered, the convex portion 12a and the concave portion 14a can be caused to engage with each other automatically. Therefore, a high-accuracy transport mechanism need not be provided, enabling the cost of the apparatus to be reduced.

The template obtained in each of the first and second embodiments is applied to the manufacture of semiconductor devices. FIG. 9 is a flowchart to explain a semiconductor device manufacturing method.

First, a template produced by a method as described in the second embodiment is prepared (S31). Next, imprinting is performed with the prepared template (S32). Specifically, after the pattern surface of the template is brought into contact with a semiconductor wafer on which an imprint agent, such as a light hardening resin, has been applied, the imprint agent is hardened, forming an imprint pattern. After imprinting is performed several times, the template is cleaned by a method as described in the first embodiment to remove the imprint agent attached to the surface of the template (S33). Thereafter, further imprinting can be performed using the cleaned template.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A template substrate processing apparatus used in imprint lithography, comprising a stage which has a convex portion that engages with a concave portion formed at an underside of the template substrate.

2. The apparatus of claim 1, wherein the convex portion has a cross-sectional area that decreases from bottom to top.

3. The apparatus of claim 2, wherein the convex portion has a tapered shape.

4. The apparatus of claim 1, further comprising a heater that heats the stage.

5. The apparatus of claim 1, wherein the template substrate processing apparatus is used for cleaning the template substrate.

6. The apparatus of claim 5, wherein the template substrate processing apparatus is a plasma cleaning apparatus.

7. The apparatus of claim 1, further comprising a high-frequency supplying module that supplies a high-frequency electric power to the stage.

8. The apparatus of claim 1, wherein the template substrate processing apparatus is an etching apparatus.

9. A template substrate processing method used in imprint lithography, comprising:
preparing a template substrate which has a concave portion at its underside;
preparing a stage which has a convex portion that engages with the concave portion of the template substrate;
placing the template substrate on the stage in such a manner that the concave portion of the template substrate engages with the convex portion of the stage; and
subjecting the template substrate placed on the stage to a specific process.

10. The method of claim 9, wherein the convex portion has a cross-sectional area that decreases from bottom to top.

11. The method of claim 10, wherein the convex portion has a tapered shape.

12. The method of claim 9, wherein the specific process is performed in a state where the stage is being heated.

13. The method of claim 9, wherein the specific process includes a process of cleaning the template substrate.

14. The method of claim 13, wherein the process of cleaning the template substrate is a plasma cleaning process.

15. The method of claim 9, wherein the specific process is performed in a state where a high-frequency electric power is being supplied to the stage.
